(19) United States
(12) Patent Application Publication
(10) Pub. No.: US 2018/0359028 A1
(43) Pub. Date: Dec. 13, 2018

(54) OPTICAL LINE TERMINAL AND FAILED TERMINAL IDENTIFICATION METHOD FOR PON COMMUNICATION SYSTEM

(71) Applicant: SUMITOMO ELECTRIC INDUSTRIES, LTD., Osaka-shi, Osaka (JP)

(72) Inventors: Hisashi KATAYAMA, Osaka-shi, Osaka (JP); Shigeharu TOYODA, Osaka-shi, Osaka (JP)

(73) Assignee: SUMITOMO ELECTRIC INDUSTRIES, LTD., Osaka-shi, Osaka (JP)

(21) Appl. No.: 15/571,281

(22) PCT Filed: Jan. 15, 2016
(86) PCT No.: PCT/JP2016/051109

§ 371 Date: Nov. 2, 2017

(30) Foreign Application Priority Data
May 8, 2015 (JP) 2015-095913

(51) Int. Cl. H04B 10/079; H04B 10/27

(52) U.S. Cl. CPC H04B 10/0791; H04B 10/27

(57) ABSTRACT

A method according to an embodiment of the present invention relates to a failure terminal identification method that can identify an optical network unit ONU having caused a failure in which the optical network unit ONU continuously sends a continuous signal. In the method, timing of upstream burst optical signal transmission is assigned to a plurality of optical network units ONUs connected to a PON communication system, intensities of upstream burst optical signals transmitted from the respective optical network units ONUs are detected and stored in advance, an intensity of an optical signal detected during a period of time ti during which transmission of an upstream burst optical signal is not assigned to any of the optical network units ONUs is recognized as an abnormal light intensity, the abnormal light intensity is compared with each of the stored intensities of upstream burst optical signals from the respective optical network units ONUs, and one or a plurality of optical network units ONUs whose difference in light intensity is determined to be smaller than a threshold value as a result of the comparison is(are) estimated as an optical network unit ONU having caused a failure or as a candidate for the optical network unit ONU having caused a failure, the failure being such that the optical network unit ONU continuously sends a continuous signal.

### TECHNICAL FIELD

The present invention relates to a technique for identifying a failure of an optical network unit in an optical data communication network that connects an optical line terminal to a plurality of optical network units, particularly, a passive optical network (PON) communication system.

### BACKGROUND ART

There is a system that performs bidirectional communication between an optical line terminal OLT and a plurality of optical network units ONUs, using an optical data communication network. Particularly, a (single star) network configuration in which an optical line terminal OLT is connected radially to each optical network unit ONU by a single optical fiber has been in practical use for a very long time. This network configuration provides a simple system and a simple device configuration. However, since a single optical network unit ONU occupies a single optical fiber, when there are N optical network units ONUs, N optical fibers that are directly connected from the optical line terminal OLT are required, making it difficult to achieve a low system cost.

In view of this, a PON communication system in which a single optical fiber drawn from an optical line terminal OLT is shared by a plurality of optical network units ONUs has been in practical use.

In the PON communication system, a single optical line terminal OLT is connected to a plurality of optical network units ONUs by optical transmission lines through a passive optical splitter (optical coupler; OC) that passively splits/multiplexes a signal(s) from signals inputted without particularly needing power supply from an external source. The optical line terminal OLT and N optical network units ONUs basically perform one-to-N transmission in which they are connected to each other through optical fibers and an optical coupler OC. By this, a large number of optical network units ONUs can be assigned to a single optical line terminal OLT, enabling to suppress the overall equipment cost.

In the PON communication system, since an optical transmission line between the optical line terminal OLT and the optical splitter is shared by a plurality of optical network units ONUs, collision avoidance measures for optical signals which are sent out from the respective optical network units ONUs are required in a direction going from the optical network units ONUs to the optical line terminal OLT (hereinafter, referred to as an “upstream direction”). Hence, the optical line terminal OLT controls optical signal send-out timing of each optical network unit ONU by a time-division access control scheme.

By the time-division access control scheme, each optical network unit ONU sends out an optical signal during a given time segment specified by the optical line terminal OLT. An optical signal thus sent out from each optical network unit ONU is called a “burst optical signal”.

As such, since in the PON communication system a plurality of optical network units ONUs are connected to a single optical line terminal OLT, if any of the optical network units ONUs causes a failure in which the optical network unit ONU goes into a state of lighting at all times, then an optical signal from the optical network unit ONU overlaps optical signals from other optical network units ONUs, causing trouble that makes it difficult to perform communication with other optical network units ONUs, too. In this case, a system administrator of the optical line terminal OLT needs to identify the optical network unit ONU in the lighting state by some kind of means, and repair or replace the optical network unit ONU having caused the failure of lighting at all times.

However, in the state of lighting at all times, since the optical line terminal OLT cannot identify an upstream packet from each optical network unit ONU, a scheme is required to identify the optical network unit ONU in the lighting state.

Patent Literature 1 specifies a trouble recovery procedure in which an optical line terminal OLT sequentially issues an extinction instruction to optical network units ONUs to stop the light emission of the optical network units ONUs, and thereby identifies a failed optical network unit ONU.

In Patent Literature 2, an optical line terminal OLT detects in advance an intensity of an upstream burst optical signal from each optical network unit ONU, and when trouble has occurred, the optical line terminal OLT detects again an intensity of an upstream burst optical signal from each optical network unit ONU, and compares light intensities of the same optical network unit ONU detected before and after the failure, to determine an optical network unit ONU with the smallest change in light intensity before and after the occurrence of trouble, as an optical network unit ONU having caused the failure in which the optical network unit ONU continuously sends a continuous signal.

In this Patent Literature 2, when any optical network unit ONU is lighted at all times, the intensity of an optical signal from each optical network unit ONU other than the failed one is such that the intensity of an optical signal from the failed optical network unit ONU is added to the intensity of the optical signal from the optical network unit ONU, and thus, the intensity of the optical signal increases. However, the intensity of the optical signal from the failed optical network unit ONU remains the same. Therefore, a failure determining unit 14 measures an intensity of an optical signal from each optical network unit ONU and stores results of the measurement, and determines candidates for a failed optical network unit ONU in ascending order of change in light intensity before and after the occurrence of trouble. By this, a failed optical network unit ONU that continuously sends a continuous signal can be identified.

### CITATION LIST

### Patent Literature

Patent Literature 1: Japanese Patent No. 4228693

Patent Literature 2: Japanese Patent No. 4798457

### SUMMARY OF INVENTION

### Technical Problem

However, in Patent Literature 1, when a large number of optical network units ONUs are connected to an optical line terminal OLT, there is a need to perform a one-by-one check procedure until a failed optical network unit ONU is found out, and thus, recovery takes time.

In addition, in Patent Literature 2, there is a need to measure an intensity of an optical signal from each failed optical network unit ONU and compare, for each optical network unit ONU, an intensity of an optical signal obtained at the present time (at the time of failure) and an intensity of an optical signal measured in the past (at normal times). Hence, a comparison needs to be performed a number of times equal to the number of optical network units ONUs, and thus, time or cost is required according to the number of optical network units ONUs.

An object of the present invention is therefore to provide an optical line terminal and a failed terminal identification method that are capable of identifying an optical network unit having caused a failure in which the optical network unit continuously sends a continuous signal, only by performing a simpler process than that of conventional art, in a PON communication system including an optical line terminal and a plurality of optical network units connected to the optical line terminal through an optical coupler.

### Solution to Problem

An optical line terminal in a PON communication system of the present invention includes a light intensity detecting unit that detects each of intensities of upstream burst optical signals transmitted from respective optical network units; a light intensity storing unit into which the detected light intensities are written for each of the optical network units; and a failure estimating unit that recognizes, as an abnormal light intensity, an intensity of an optical signal detected during a period of time during which transmission of an upstream burst optical signal is not assigned to any of the optical network units, compares the abnormal light intensity with each of the intensities of upstream burst optical signals from the respective optical network units written into the light intensity storing unit, and estimates one or a plurality of optical network units whose difference in light intensity is determined to be smaller than a threshold value as a result of the comparison, as an optical network unit having caused a failure or as a candidate for the optical network unit having caused a failure, the failure being such that the optical network unit continuously sends a continuous signal.

According to the optical line terminal, timing of upstream burst optical signal transmission is assigned to the plurality of optical network units, intensities of upstream burst optical signals transmitted from the respective optical network units are detected and stored in advance, an intensity of an optical signal detected during a period of time during which transmission of an upstream burst optical signal is not assigned to any of the optical network units is recognized as an abnormal light intensity, the recognized abnormal light intensity is compared with each of the stored intensities of upstream burst optical signals from the respective optical network units, and an optical network unit whose difference in light intensity is determined to be smaller than the threshold value as a result of the comparison is estimated as an optical network unit having caused a failure in which the optical network unit continuously sends a continuous signal.

In addition, when, as a result of the comparison, there are a plurality of optical network units with a small difference in light intensity and thus it is difficult to accurately determine an optical network unit having caused a failure, optical network units whose difference in light intensity is smaller than the threshold value are selected as a plurality of candidates for a failed optical network unit. By this, an optical network unit suspected to have caused a failure can be narrowed down from all optical network units connected to the PON communication system.

It is desirable that the timing at which the light intensity detecting unit detects in advance the intensities of upstream burst optical signals from the respective optical network units be when the optical line terminal performs normal communication with all optical network units.

The failure estimating unit can identify in a short time an optical network unit ONU in a state of emitting light at all times, as an optical network unit having caused a failure, the state being detected by issuing an extinction/light emission command only to the estimated one or plurality of optical network units.

In addition, a failure terminal identification method for a PON communication system of the present invention is a method according to substantially the same invention as the above-described invention of the optical line terminal in the PON communication system.

### Advantageous Effects of Invention

As described above, according to the present invention, an advantageous effect is obtained that the optical line terminal can estimate a failed optical network unit that continuously sends a continuous signal and thus can promptly get down to the operation of identifying a failed optical network unit.

### BRIEF DESCRIPTION OF DRAWINGS

FIG. 1 is a schematic diagram showing an exemplary configuration of a PON communication system.

FIG. 2 is a configuration diagram of an upstream signal receiving unit 1 of an optical line terminal OLT.

FIG. 3 is a graph showing the waveforms of received light intensities Pin of a series of burst optical signals from respective optical network units ONUs.

FIG. 4 is a graph showing the waveforms of received light intensities Pin of a series of burst optical signals from respective optical network units ONUs for a case in which any of the optical network units ONUs emits light at all times and thus upstream optical communication in the PON communication system cannot be performed.

### DESCRIPTION OF EMBODIMENTS

An embodiment of the present invention will be described below with reference to the accompanying drawings.

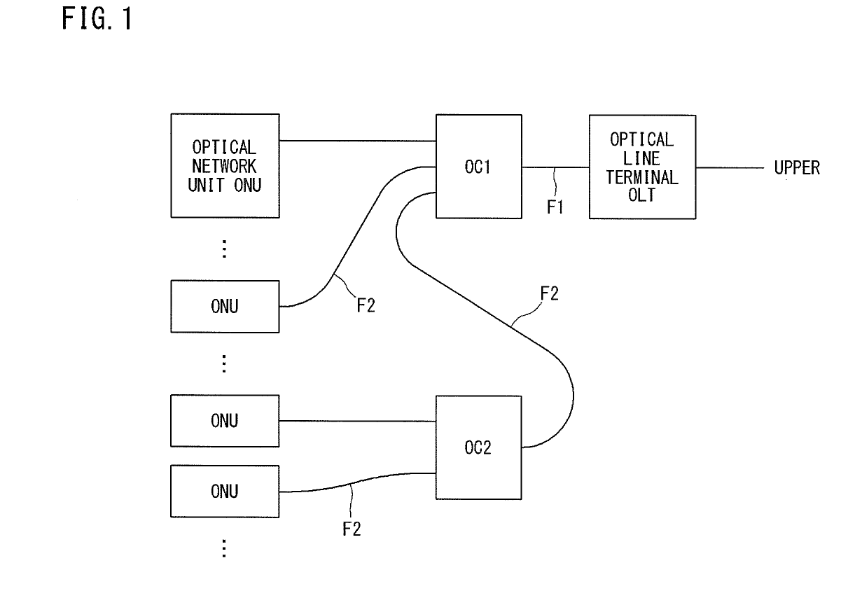

FIG. 1 is a schematic diagram showing an exemplary configuration of a PON communication system.

In the PON communication system, optical network units ONUs provided in a plurality of subscribers' homes are connected to an optical line terminal OLT provided in a central office, in a tree topology through a trunk optical fiber F1, optical couplers OC1 and OC2, and branch optical fibers F2.

Specifically, the optical line terminal OLT is connected to the optical coupler OC1 through the trunk optical fiber F1, and the optical coupler OC1 is connected to one or a plurality of optical network units ONUs and connected to one or a plurality of second optical couplers OC2. The second optical coupler OC2 is connected to a plurality of optical network units ONUs by branch optical fibers F2.

Note that although FIG. 1 shows two optical couplers OCs serving as network tree branch points, the number of optical couplers OCs is not limited to “2.” The number of optical couplers OCs may be any number greater than or equal to one. The number of optical network units ONUs to be connected is not limited, either.

Each of the trunk optical fiber F1 and branch optical fibers F2 uses one single-mode fiber. The optical couplers OCs each are composed of a star coupler that passively splits/multiplexes a signal(s) from signals inputted without particularly needing power supply from an external source.

Each of the optical network units ONUs includes a network interface for establishing a connection with a terminal device for enjoying optical network services, such as a personal computer or a television set installed in a subscriber's home.

An upstream line and a downstream line use light of different wavelengths, providing a mechanism in which collisions between upstream and downstream signals do not occur. Thus, a signal transmitted from the optical line terminal OLT is distributed to the plurality of optical network units ONUs through the optical coupler OC1 and the second optical coupler OC2, and signals transmitted from the respective optical network units ONUs are collected at the optical line terminal OLT.

A downstream frame included in a signal that comes into the optical line terminal OLT from an upper network is subjected to a predetermined process by the optical line terminal OLT, by which a logical link to relay is identified. Then, the downstream frame is transmitted as an optical signal to the trunk optical fiber F1 through the optical line terminal OLT. The optical signal transmitted to the trunk optical fiber F1 is split by the optical coupler OC and transmitted to an optical network unit ONU connected to the optical coupler OC; here, only an optical network unit ONU forming the logical link can capture a predetermined optical signal and relays the frame to an in-house network interface.

On the other hand, an upstream optical signal includes an upstream frame from each optical network unit ONU. The upstream frames need to be transmitted such that the upstream frames from the respective optical network units ONUs do not temporally conflict with each other. To do so, the optical line terminal OLT assigns window periods (which may be hereinafter referred to as windows or timing) during which an upstream optical signal is allowed to be transmitted, to the optical network units ONUs in turn. The optical line terminal OLT notifies about the assignment information as a control frame. An optical network unit ONU assigned a window transmits an upstream optical signal during the window assigned to the optical network unit ONU. This method is a kind of time-division multiplexing scheme, and an upstream optical signal sent out from each optical network unit ONU is referred to as a “burst optical signal”.

In this manner, confliction between upstream optical signals from the optical network units ONUs is avoided. When each optical network unit ONU is given a window, the optical network unit ONU may continuously transmit as many frames as the window can contain.

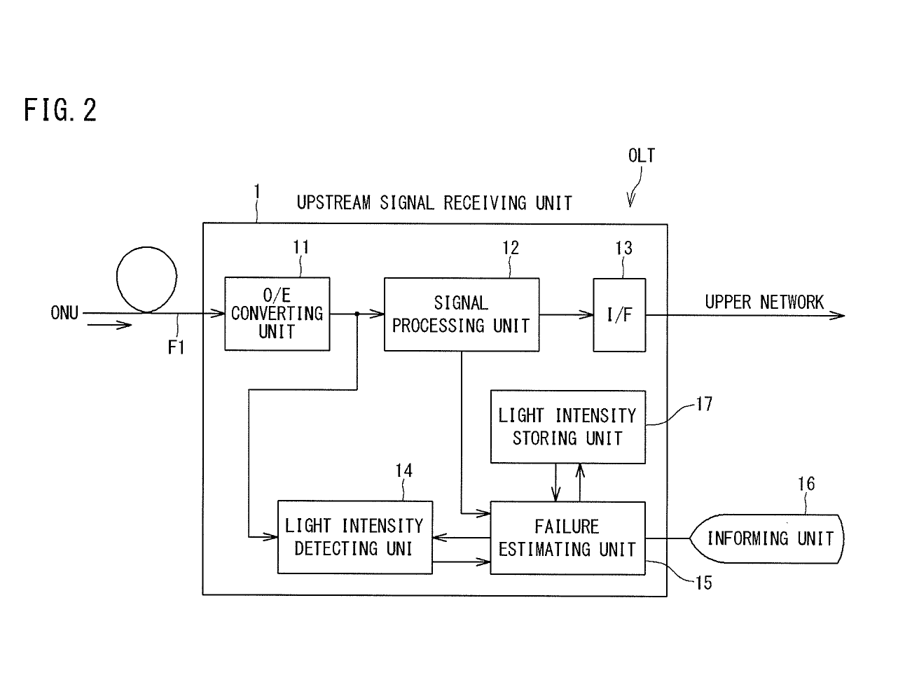

FIG. 2 shows a configuration of an upstream signal receiving unit 1 of the optical line terminal OLT. The upstream signal receiving unit 1 includes an O/E converting unit 11 that converts an optical signal coming in from an optical network unit ONU through the optical fiber F1 into an electrical signal; and a signal processing unit 12 that decodes and processes the converted electrical signal. The upstream signal receiving unit 1 further includes an interface unit 13 for sending out the signal processed by the signal processing unit 12 to the upper network.

In addition to the above, the upstream signal receiving unit 1 includes a light intensity detecting unit 14 that detects a level of an optical signal from each optical network unit ONU; a failure estimating unit 15 that estimates a failure of any optical network unit ONU; and an informing unit 16 that informs the system administrator of information on the optical network unit ONU whose failure has been estimated, by an indicator such as an LED or a liquid crystal display. The upstream signal receiving unit 1 further includes a light intensity storing unit 17 that holds a value obtained by converting an average value of light intensities received from each optical network unit ONU into a numeric value.

The signal processing unit 12 and the failure estimating unit 15 include a processor that performs a logical operation process, e.g., a central processing unit (CPU), a micro-processing unit (MPU), or a field-programmable gate array (FPGA). The signal processing unit 12 and the failure processing unit 15 may be composed of one processor or may be composed of different processors.

For the light intensity detecting unit 14, for example, a light measurement circuit including a current mirror circuit, a DC-DC converter, an MPU, and the like (see Japanese Unexamined Patent Publication No. 2011-252716) can be adopted.

The light intensity storing unit 17 is composed of a memory, e.g., a random access memory (RAM) or a flash memory.

The O/E converting unit 11 includes a photoelectric conversion element such as a photodiode, and converts a burst optical signal coming in through the optical fiber F1 into an electrical signal. The signal processing unit 12 achieves synchronization of received data having been converted into the electrical signal, and performs error correction on the received data using parity. The error-corrected received data is subjected to a decoding process and passed to the upper network through the interface unit.

In addition, the signal processing unit 12 notifies the failure estimating unit 15 of information on a window period of each optical network unit ONU (information indicating at which time a burst optical signal from which optical network unit ONU comes in) and information on an idle period (described later) (information indicating at which time an idle period is set). As a prerequisite therefor, the signal processing unit 12 and the failure estimating unit 15 need to operate by a common clock.

The electrical signal converted by the O/E converting unit 11 is also distributed and supplied to the light intensity detecting unit 14. The light intensity detecting unit 14 detects a level of the optical signal from the optical network unit ONU, based on the magnitude of the electrical signal.

The failure estimating unit 15 provides, at a predetermined time, an instruction to start the detection of a light intensity from each optical network unit ONU, to the light intensity detecting unit 14. The time at which the instruction is provided may be any time point at which normal communication is performed in the PON system, and can be arbitrarily set by the failure estimating unit 15. The time may be, for example, immediately after the PON system starts up, immediately after an optical network unit ONU newly joins, a predetermined time of a day, or a time that is determined by the system administrator as appropriate, and is a time at which abnormalities are not found in optical communication in the PON system.

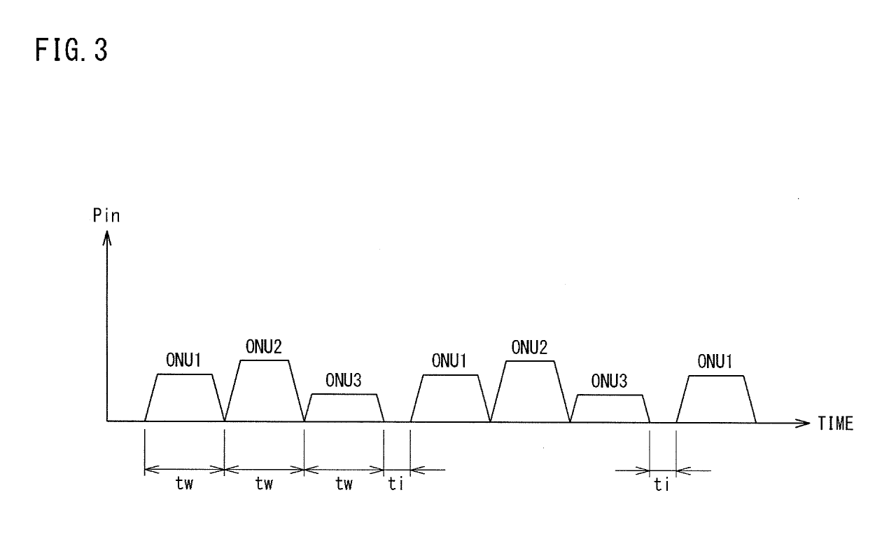

FIG. 3 is a graph showing the waveforms of received light intensities Pin of a series of burst optical signals from the respective optical network units ONUs which are detected by the light intensity detecting unit 14. The graph starts at a time (time t=0) at which an instruction to start the detection of light intensities is provided from the failure estimating unit 15. Although FIG. 3 shows three optical network units ONUs, the number of optical network units ONUs is not limited thereto (in practice, more optical network units ONUs are connected). However, in the following, for convenience sake, description is made with the number of optical network units ONUs being three.

As shown in FIG. 3, the light intensity detecting unit 14 receives a burst optical signal from an optical network unit ONU1, and subsequently receives a burst optical signal from an optical network unit ONU2, and subsequently receives a burst optical signal from an optical network unit ONU3. In FIG. 3, the intensity received from the optical network unit ONU2 is strongest and the received intensity gets weaker in the order of the optical network units ONU1 and ONU3, which is because the characteristics of light-emitting elements of the optical network units ONUs 1 to 3 and the characteristics of optical transmission lines such as the lengths of optical fibers vary when viewed from the optical line terminal OLT.

When the optical line terminal OLT assigns window periods to the optical network units ONUs, the optical line terminal OLT sets an “idle period” during which all optical network units ONUs are not allowed to emit light, and notifies each optical network unit ONU of the idle period.

In FIG. 3, each window period is indicated by “tw.” An idle period during which all optical network units ONUs are inhibited from emitting light is provided between window periods tw. The idle period is indicated by “ti.”

The original meaning of providing the idle period ti is to have a margin so that burst optical signals from the respective optical network units ONUs do not overlap each other. An idle period ti does not necessarily need to be provided between adjacent optical network units ONUs, and there may be a case in which an idle period ti is not provided between adjacent optical network units ONUs (in FIG. 3, an idle period ti is not provided between the optical network units ONU1 and ONU2 and between the optical network units ONU2 and ONU3, but is provided between the optical network units ONU3 and ONU1). While the window period tw is normally about 15 microseconds, the idle period ti is set in a range from 0 seconds to about 1 microsecond.

When normal communication is performed in the PON system, as can be seen from the definition of the idle period ti that “all optical network units ONUs are inhibited from emitting light”, during the idle period ti, the intensity of an optical signal detected by the light intensity detecting unit 14 is supposed to be zero.

However, if an optical network unit ONU starts to emit light at all times due to a failure, it becomes impossible to decode upstream burst optical signals from other normal optical network units ONUs. In such a case, even during an idle period ti, the intensity of an optical signal detected by the light intensity detecting unit 14 does not become zero. In the present invention, using an optical signal appearing during the idle period, a failed optical network unit ONU is estimated. A method of estimating a failed optical network unit will be described below.

The light intensity detecting unit 14 detects an intensity of each optical signal through a predetermined low-pass filter included therein at a time point of each window period tw, in response to an instruction to start the detection of light intensities from the failure estimating unit 15. Information on the detected light intensities is passed to the failure estimating unit 15. The failure estimating unit 15 converts the light intensities into numeric values. The conversion of the light intensities into numeric values can be performed by determining, for example, an amplitude envelope of a signal passed from the light intensity detecting unit 14 and performing A/D conversion on the amplitude envelope.

Note that an optimal time constant is selected for the low-pass filter of the light intensity detecting unit 14 so that an average level of an optical signal for each window period and each idle period can be detected.

The failure estimating unit 15 writes the values of the light intensities for the window periods tw into the light intensity storing unit 17. By the writing from the failure estimating unit 15, the light intensity storing unit 17 writes the values of the light intensities for the respective window periods tw into a memory element, together with times at which the light intensities are detected by the light intensity detecting unit 14. Handling of a history of memory is not limited, but, for example, when a value is stored at a new time, an old value stored for a corresponding window period tw may be deleted, or without deleting the old value, a plurality of values stored for the window period tw may be stored in chronological order.

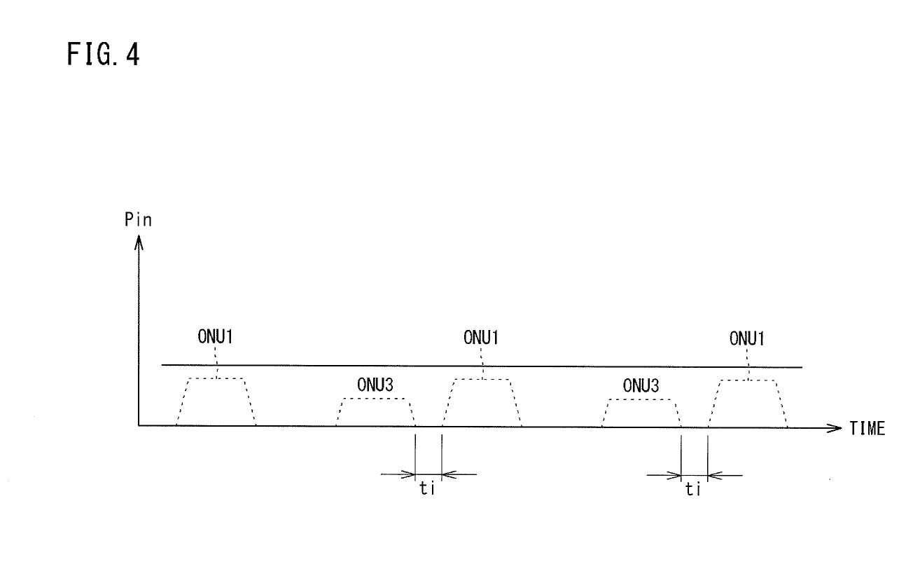

FIG. 4 is a graph showing the waveforms of received light intensities Pin of a series of burst optical signals from respective optical network units ONUs for a case in which any of the optical network units ONUs emits light at all times and thus upstream optical communication in the PON communication system cannot be performed.

Since the optical network unit ONU2 emits light at all times, as can be seen from the graph of FIG. 4, light from the failed optical network unit ONU2 is added to burst optical signals from other optical network units ONUs, and accordingly, the burst optical signals from the optical network units ONUs 1 and 3 are hidden in the light from the optical network unit ONU2 and become difficult to decode.

Hence, the failure estimating unit 15 performs is the following steps to identify an optical network unit ONU that is estimated to be a failed optical network unit ONU, by referring to the values stored in the light intensity storing unit 17 upon the occurrence of trouble.
(1) The failure estimating unit 15 instructs the light intensity detecting unit 14 to measure an intensity of an optical signal during an idle period ti.
(2) The failure estimating unit 15 converts the light intensity measured by the light intensity detecting unit 14 into a numeric value, and temporarily stores the numeric value in a buffer area in the failure estimating unit 15.
(3) The failure estimating unit 15 compares the intensity of the optical signal for the idle period ti with the values of light intensities of the respective optical network units ONUs for normal times of the PON system which are stored in the light intensity storing unit 17.
(4) Difference is taken between the values of the intensities of optical signals of the respective optical network units ONUs stored in the light intensity storing unit 17 and the value of the light intensity for the idle period ti. If any of the differences is smaller than a predetermined threshold value, a corresponding optical network unit ONU is estimated to be an optical network unit ONU that appears to emit light at all times.
(5) Note, however, that if there are a plurality of optical network units ONUs whose differences between the value of the light intensity for the idle period ti and the intensities of optical signals of the respective optical network units ONUs stored in the light intensity storing unit 17 are smaller than the threshold value, each of those optical network units ONUs is selected as a candidate for a failed optical network unit ONU.
(6) The optical line terminal OLT takes measures to increase the accuracy of a failure determination for the one or plurality of optical network units ONUs that are estimated to appear to emit light at all times. Specifically, a DPoE OAM message (referred to as an extinction/light emission command) that controls the extinction/light emission of light output is transmitted to the one or plurality of candidate optical network units ONUs to stop light emission. Here, DPoE (Docsis Providing of EPON) refers to a standard standardized to provide, by cable television operators, high-speed communication services in which a transmission line is replaced from a conventional coaxial cable to an optical fiber. OAM (Operation Administration and Maintenance) refers to a message to control the optical network units ONUs by the optical line terminal OLT.

The extinction/light emission command is also effective for an optical network unit ONU that emits light at all times due to a failure. If, when the light emission is stopped, the signal processing unit 12 becomes able to decode signals from optical network units ONUs other than the one or plurality of candidate optical network units ONUs, it can be determined that the one optical network unit ONU is a failed optical network unit ONU. Alternatively, it can be determined that any of the plurality of candidate optical network units ONUs is a failed ONU.
(7) When it is determined that any of the plurality of candidate optical network units ONUs is a failed ONU, thereafter, a DPoE OAM message (0xD9/0x0605) is transmitted to the plurality of candidate optical network units ONUs to allow the plurality of candidate optical network units ONUs to emit light again one by one. First, if, when the first optical network unit ONU is allowed to emit light again, the signal processing unit 12 can normally read the content of optical signals from other optical network units ONUs, it can be determined that the first optical network unit ONU is not a failed ONU that emits light abnormally. In this manner, the second, third, . . . optical network units ONUs are allowed to emit light again. If, when a given optical network unit ONU is allowed to emit light again, the content of optical signals from other optical network units ONUs cannot be read normally, it can be determined that the optical network unit ONU is a failed ONU that emits light abnormally.

As such, by the above-described steps (1) to (5), an optical network unit ONU that appears to emit light at all times can be estimated.

Since, as shown in (6) and (7), an extinction/light emission command is transmitted only to the estimated optical network unit(s) ONU(s), the time required to find an optical network unit ONU emitting light abnormally is reduced compared to a technique in which an extinction/light emission command is transmitted to all optical network units ONUs present in a PON system as in the conventional technique described in Patent Literature 1. This is because, since an extinction/light emission command does not need to be issued to normal optical network units ONUs that are determined not to emit light at all times at the steps (1) to (5), search time can be saved correspondingly.
(8) After identifying the failed optical network unit ONU, the identified optical network unit ONU is displayed on the informing unit 16 to provide a notification to the system administrator by an alert function such as an SNMP Trap, email, etc., enabling to urge the system administrator to go to the location of the optical network unit ONU for a checkup.

Although the embodiment of the present invention has been described above, the implementation of the present invention is not limited to the above-described embodiment and various changes may be made to the embodiment without departing from the spirit and scope of the present invention.

### REFERENCE SIGNS LIST

1: UPSTREAM SIGNAL RECEIVING UNIT
11: O/E CONVERTING UNIT
12: SIGNAL PROCESSING UNIT
13: INTERFACE UNIT
14: LIGHT INTENSITY DETECTING UNIT
15: FAILURE ESTIMATING UNIT
16: INFORMING UNIT
17: LIGHT INTENSITY STORING UNIT

1. An optical line terminal used in a passive optical network (PON) communication system including the optical line terminal and a plurality of optical network units connected to the optical line terminal through an optical coupler, the optical line terminal comprising:
a light intensity detecting unit that detects each of intensities of upstream burst optical signals transmitted from the respective optical network units;
a light intensity storing unit into which the detected light intensities are written for each of the optical network units; and
a failure estimating unit that recognizes, as an abnormal light intensity, an intensity of an optical signal detected during a period of time during which transmission of an upstream burst optical signal is not assigned to any of the optical network units, compares the abnormal light intensity with each of the intensities of upstream burst optical signals from the respective optical network units written into the light intensity storing unit, and estimates one or a plurality of optical network units whose difference in light intensity is determined to be smaller than a threshold value as a result of the comparison, as an optical network unit having caused a failure or as a candidate for the optical network unit having caused a failure, the failure being such that the optical network unit continuously sends a continuous signal.

2. The optical line terminal according to claim 1, wherein the light intensities written into the light intensity storing unit are intensities of upstream burst optical signals from the respective optical network units that are detected in advance by the light intensity detecting unit when the optical line terminal performs normal communication with all the optical network units.

3. The optical line terminal according to claim 1, wherein the failure estimating unit identifies, as an optical network unit having caused a failure, an optical network unit in a state of emitting light at all times, the state being detected by issuing an extinction/light emission command to the estimated one or plurality of optical network units.

4. A failed terminal identification method for estimating a failed optical network unit by an optical line terminal used in a passive optical network (PON) communication system including the optical line terminal and a plurality of optical network units connected to the optical line terminal through an optical coupler, the method comprising:
assigning timing of upstream burst optical signal transmission to the plurality of optical network units;
detecting and storing in advance intensities of upstream burst optical signals transmitted from the respective optical network units;
recognizing, as an abnormal light intensity, an intensity of an optical signal detected during a period of time during which transmission of an upstream burst optical signal is not assigned to any of the optical network units;
comparing the abnormal light intensity with each of the stored intensities of upstream burst optical signals from the respective optical network units; and
estimating one or a plurality of optical network units whose difference in light intensity is determined to be smaller than a threshold value as a result of the comparison, as an optical network unit having caused a failure or as a candidate for the optical network unit having caused a failure, the failure being such that the optical network unit continuously sends a continuous signal.
